(19) United States
(12) Patent Application Publication
(10) Pub. No.: US 2017/0191273 A1
(43) Pub. Date: Jul. 6, 2017

(54) SOLAR BATTERY POWERED AWNING

(71) Applicant: SUNSETTER PRODUCTS LIMITED PARTNERSHIP, Malden, MA (US)

(72) Inventors: Ido Eilam, Newton, MA (US); Timothy Alan McCoy, Swampscott, MA (US)

(21) Appl. No.: 14/988,006

(22) Filed: Jan. 5, 2016

(51) Int. Cl. E04F 10/06; H02S 40/38; H02J 7/00; F21V 33/00; H02J 7/35; H02S 20/26; H01R 24/60

(52) U.S. Cl. CPC E04F 10/0611; E04F 10/0666; H02S 20/26; H02S 40/38; H01R 24/60; F21V 33/006; H02J 7/35; H02J 7/0047; H02J 7/0052; H01R 2107/00

(57) ABSTRACT

A solar battery powered awning system is provided having a controller operative to monitor battery power and to shut off power to lights and/or other accessories when the battery power falls below a reference level, such that the battery has sufficient energy to operate the motor and close the awning. A visual and/or audible indication can be provided to alert users that battery power is getting low.

### STATEMENT REGARDING FEDERALLY SPONSORED RESEARCH OR DEVELOPMENT

N/A

### BACKGROUND OF THE INVENTION

Outdoor awnings are widely used to provide shade to residential and other patios, decks, yards and the like. Such awnings may be mounted on a wall of a home or building for unfurling over a space to be shaded, or may be free standing on a patio or other area. The awnings may be opened and closed by use of a hand crank or by motor powered roller. Motor powered awnings can operate from standard house current or can be battery powered to avoid the need for an electrical cord extending from the awning unit to an electrical receptacle which is usually on an outer wall of a home or other building structure. Battery powered awnings having solar panels for charging the battery are also known.

One difficulty with battery powered awnings is that if battery power is too low, the awning may be stuck in an open position and not be closable until the battery is recharged or replaced. Leaving an awning, particularly a free standing awning, in an open position can be damaging to the awning in the presence of high winds or heavy rain. In addition, particularly with free standing awnings, leaving the awning unfurled under conditions of high wind or rain can pose a danger to people who may be present or to surrounding property as the awning could tip over or tumble.

### BRIEF SUMMARY OF THE INVENTION

In accordance with the present invention, a solar battery powered awning system is provided having a controller operative to monitor battery power and to shut off power to lights and/or other accessories when the battery power falls below a reference level, such that the battery has sufficient energy to operate the motor and close the awning. A visual and/or audible indication can be provided to alert users that battery power is getting low.

The system includes a stand and housing containing an awning material rolled about a roller assembly which is driven by a drive assembly having a motor to open and close the awning. The motor is driven by a battery powered source and the battery is charged from one or more solar panels disposed on or in association with the housing. The battery may also be charged from a charger which may be AC powered. An array of lights, typically LED lights, are mounted on the awning and positioned to illuminate an area beneath the awning. The system includes a controller, typically a microprocessor based microcontroller, which is operative to monitor battery voltage and to disconnect battery power to the lights when battery power is detected to be below a reference level. In this manner, sufficient battery power is maintained to close the awning and avoid the possibly deleterious effects of leaving the awning in an open position because the battery was too low to power the motor for awning closure.

The awning system may include one or more USB ports for charging cell phones, tablets and other portable electronic devices. These ports can be powered by the battery source and to conserve battery power the battery can be disconnected from the ports when the battery power is detected by the controller to be less than the reference level.

Typically the awning is controlled by a wireless remote unit which is wirelessly coupled to the processor by a wireless communications link such as radio, ultrasound or infrared light. The awning system may also be controlled by control switches associated with the housing. Alternatively, the invention can be implemented in an umbrella system such as a patio umbrella.

### BRIEF DESCRIPTION OF THE SEVERAL VIEWS OF THE DRAWINGS

The invention will be further understood from the following detailed description in conjunction with the drawings in which:

FIG. 1 is a pictorial view of the awning system in an open position;

FIG. 2 is a pictorial view of the awning system in a closed position; and

FIG. 3 is a block diagram of the control system for the awning.

### DETAILED DESCRIPTION OF THE INVENTION

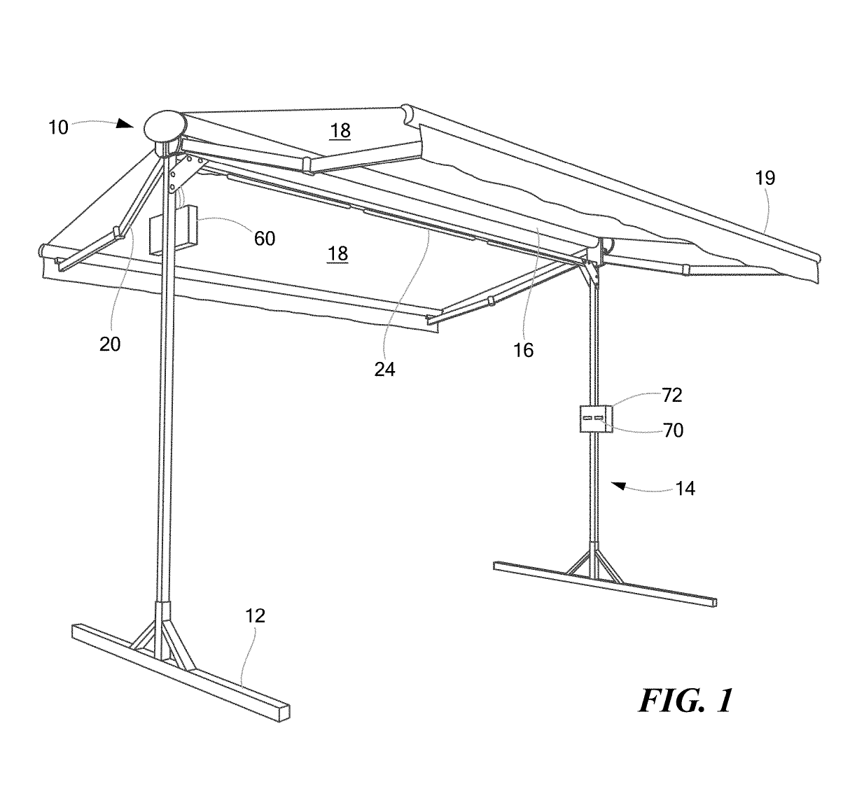

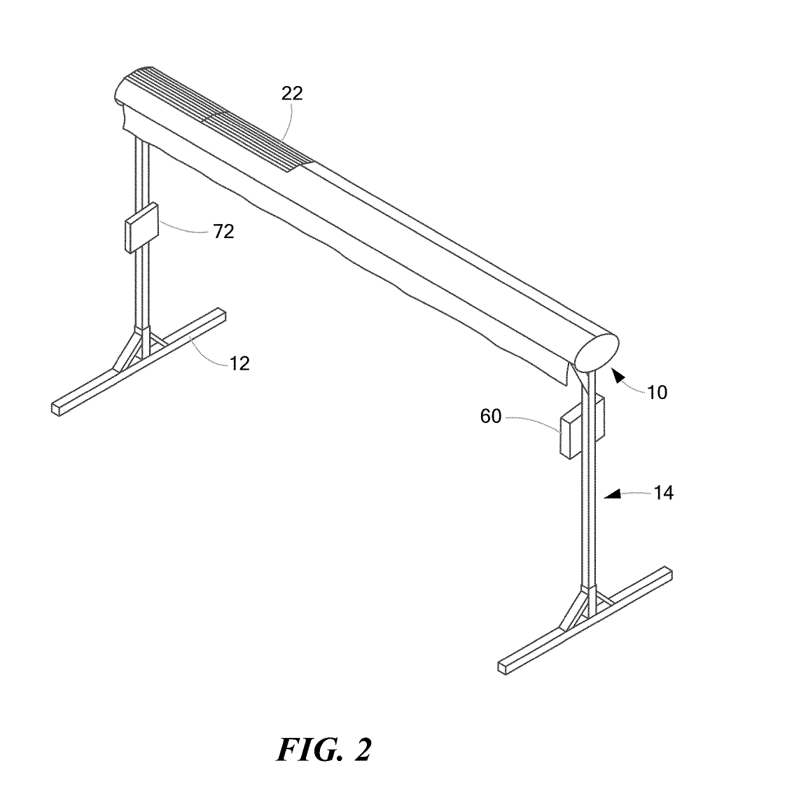

The awning system is shown in open position in FIG. 1 and in closed position in FIG. 2. The system includes a housing 10 supported on legs 12 of a stand 14. A roller or drive assembly 16 is beneath the housing 10 and to which one end of each of two awning fabrics 18 is attached. The outer end of each awning fabric is affixed to a respective front bar 19 which is connected to a folding mechanism 20. A motor (not shown) is contained within one end of the drive roller and is operative to rotate the roller for furling and unfurling the awning fabric. One awning section furls about the top of the roller and the other awning fabric furls about the bottom of the roller. The awning assembly for retracting and opening the awning fabric and for supporting the awning at a suitable height can be of various constructions and is per se known. A preferred awning assembly is known commercially as the SunSetter Oasis Awning, sold by the Assignee of the present invention.

One or more solar panels 22 are supported on an upper surface of housing 10. In the illustrated embodiment a solar panel is shown on one side of the housing. Solar panels may be provided on both ends of the housing or along the entire housing length or spaced therealong to provide intended power output. The solar panels are electrically connected to a battery charger which in turn is coupled to the one or more batteries of a battery power source.

An array of LED lights 24 are provided beneath the awning for illumination of the area below the awning, as shown in FIG. 1. In the illustrated embodiment, the LED lights are disposed within tubes which are supported on a top rail of the stand. It will be appreciated that the lights may be variously positioned to provide intended illumination intensity and pattern. The lights are connected to the battery source via a controller.

One or more USB or other charging ports can be provided on the awning system in any convenient position. In FIG. 1, two ports 70 are shown on an enclosure 72 mounted to the stand.

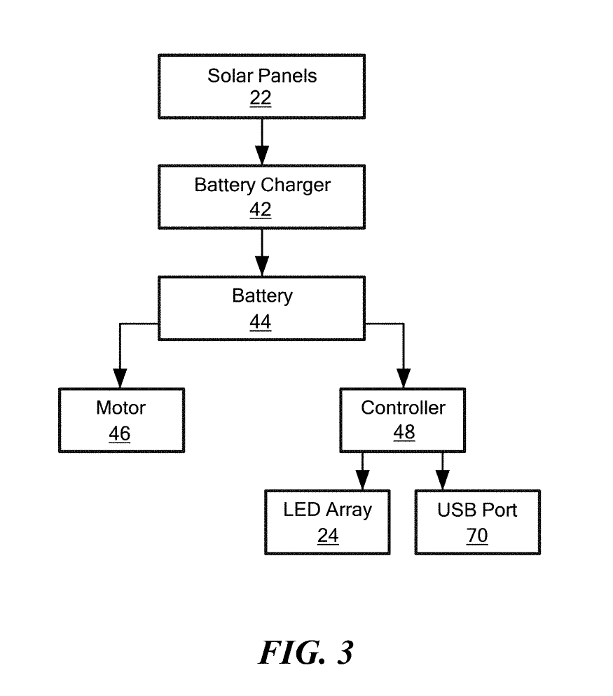

A block diagram of the system is shown in FIG. 3. The one or more solar panels 22 are connected to a battery charger 42 which typically is an integrated circuit (IC) charger which in turn is connected to a battery source 44 having one or more batteries to provide an intended DC voltage. Typically battery voltage is 12-16 volts DC. The battery source 44 is connected to electrical motor 46 and to controller 48. The controller is connected to the LED or other light array 24, and to the one or more USB ports 70.

The controller 48 is typically a microcontroller which is operative to monitor battery voltage and to compare the monitored voltage with a reference voltage level. If the monitored voltage falls below the reference level, the controller disconnects power to the LED array 24 and to ports 70 thereby to conserve battery power. When the battery is recharged from the solar panels or from a subsidiary charging source, and the battery voltage is then at or above the reference level, the controller 48 resumes provision of power to LED array 24 and to charging ports 70.

The controller is typically implemented by one or more integrated circuits mounted on a printed circuit board, and the driver circuitry for the LEDs is also typically implemented as one or more integrated circuits mounted on a circuit board. The circuit boards and associated battery pack are contained within an electrical box 60 mountable in any convenient location in the awning housing 10 or on the structure. As shown in FIGS. 1 and 2 the electrical box 60 is shown mounted at one end of the awning structure. The electrical components including the solar panels, LED array, motor, controller and battery pack are interconnected by suitable wiring and electrical connectors in any manner well known in the art. The electrical box may be positioned in other locations to suit particular operational or esthetic wishes. Alternatively, the battery may be contained in a separate housing for convenient access for battery replacement.

The awning system may be used for example as a convenient gathering site for persons who would benefit from an area having sun protection during sunny days, and built in lighting for use at night or cloudy days. The system can also include charging ports for phones, tablets and other such devices. Such a site would be particularly attractive for student groups at university and college campuses as a place to gather for study and conversation, or in hotel or resort grounds as a meeting place.

It will be appreciated that the invention may be embodied in a variety of awning, umbrella and other similar retractable structures. Therefore the invention is not to be limited by what has been particularly shown and described except as indicated in the appended claims.

What is claimed is:

1. A solar battery powered awning system comprising:
a housing containing an awning rolled about an awning roller;
a drive assembly having a motor coupled to the awning roller for driving the roller to open and close the awning;
a plurality of lights associated with the awning and positioned to illuminate an area beneath the awning;
a battery source coupled to the drive assembly for powering the motor;
one or more solar panels associated with the housing and operative to charge the battery source; and
a controller coupled to the battery source and to the plurality of lights and operative to power the plurality of lights and operative to monitor battery power and disconnect battery power to the plurality of lights when battery power is below a reference level and reconnect battery power to the plurality of lights when battery power is at or above the reference level.

2. The system of claim 1 wherein the housing is mounted on a stand for support of the system on a mounting surface.

3. The system of claim 1 wherein the controller includes a microcontroller and comparator circuitry for comparing battery power to a reference level and providing an output signal in response to the comparison.

4. The system of claim 1 including a wireless remote control device for control of system operation.

5. The system of claim 1 including controls associated with the housing for control of system operation.

6. The system of claim 1 including an audible and/or visible alert indicator to denote a low battery condition.

7. The system of claim 1 including at least one USB port associated with the housing and coupled to the battery source for charging portable electronic devices.

8. The system of claim 7 wherein the controller is also operative to disconnect battery power to the at least one USB port when battery power is below a reference level and to reconnect battery power to the at least one USB port when battery power is at or above the reference level.

9. The system of claim 1 wherein the battery source includes one or more batteries and a battery charger coupled to the one or more batteries.
